(19) United States
(12) Patent Application Publication
(10) Pub. No.: US 2024/0294775 A1
(43) Pub. Date: Sep. 5, 2024

(54) COATING MATERIAL FOR UNDERWATER STRUCTURES, UNDERWATER STRUCTURE, AND METHOD FOR PRODUCING UNDERWATER STRUCTURE WITH COATING MATERIAL

(71) Applicant: ASAHITECH CO., LTD., Nagasaki (JP)

(72) Inventor: Osamu IKEDA, Nagasaki (JP)

(21) Appl. No.: 18/591,271

(22) Filed: Feb. 29, 2024

Related U.S. Application Data
(60) Provisional application No. 63/488,234, filed on Mar. 3, 2023.

(51) Int. Cl. C09D 5/16

(52) U.S. Cl. CPC C09D 5/1625; C09D 5/1656

(57) ABSTRACT

A coating material for underwater structures includes: iron (II) fulvate generated by causing at least iron (II) sulfate and a fulvic acid to react, an outer surface of an underwater structure that is at least partially installed in water being coated with the coating material.

### BACKGROUND OF THE INVENTION

The present disclosure relates to a coating material for underwater structures related to underwater structures that are at least partially installed in water, an underwater structure, and production of an underwater structure with a coating material.

In recent years, seaweeds such as algae have decreased and sea desertification has advanced in coastal areas and the like. This is because the amount of iron fulvate, which used to be generated in forest humic planting soil and flow from rivers, has decreased in recent years and nutrients necessary for seaweeds have become insufficient. Patent Literature (PTL) 1 discloses an aquatic environment preservation material, in which a divalent iron-containing substance and a humus-containing substance are caused to be present, from which iron fulvate is eluted in a state where the material is submerged in water.
PTL 1: JP 2006-81457 A

### SUMMARY OF THE INVENTION

Incidentally, underwater structures such as wave-dissipating blocks and breakwaters are present in water, and concrete is often used in components of the underwater structures. Calcium hydroxide contained in the concrete reacts with iron fulvate in water, and the iron fulvate is brought into a trivalent state where it does not contribute to growth of seaweeds. As a result, it is difficult to curb the progress of sea desertification even if an aquatic environment preservation material as in PTL 1 is used as long as underwater structures are present in an exposed manner in water.

Thus, it would be helpful to provide a coating material for underwater structures capable of supplying nutrients to seaweeds for a longer period of time even if underwater structures containing concrete or the like are used, and an underwater structure covered with the coating material.

A coating material for underwater structures according to the present disclosure includes: iron (II) fulvate generated by causing at least iron (II) sulfate and a fulvic acid to react, an outer surface of an underwater structure that is at least partially installed in water being coated with the coating material.

An underwater structure according to the present disclosure includes: a main body; and a coating material provided on an outer surface of the main body and containing iron (II) fulvate generated by causing iron (II) sulfate and a fulvic acid to react.

A method for producing an underwater structure with a coating material according to the present disclosure includes: forming an underwater structure that is for being at least partially installed in water; and coating an outer surface of the underwater structure with a coating material containing iron (II) fulvate generated by causing at least iron (II) sulfate and a fulvic acid to react.

According to the present disclosure, it is possible to supply nutrients to seaweeds for a longer period of time even if underwater structures are used.

### BRIEF DESCRIPTION OF DRAWINGS

FIG. 1 is a perspective view of an artificial reef according to an embodiment of the present disclosure;

FIG. 2 is a sectional view of the artificial reef according to the embodiment of the present disclosure;

FIGS. 3A to 3E are explanatory diagrams of a process of producing the artificial reef according to the embodiment of the present disclosure;

FIG. 4 is an explanatory diagram of a function of the artificial reef according to the embodiment of the present disclosure;

FIG. 5 is an explanatory diagram of a quay and wave-dissipating blocks according to the embodiment of the present disclosure;

FIG. 6 is a side view of the quay and the wave-dissipating blocks according to the embodiment of the present disclosure;

FIG. 7 is a sectional view of the quay according to the embodiment of the present disclosure;

FIGS. 8A and 8B are an explanatory diagram and a sectional view of the wave-dissipating block according to the embodiment of the present disclosure;

FIG. 9 is a side view of a breakwater and the wave-dissipating blocks according to the embodiment of the present disclosure; and

FIG. 10 is a sectional view of the breakwater according to the embodiment of the present disclosure.

### DETAILED DESCRIPTION OF THE INVENTION

Hereinafter, an embodiment of the present disclosure will be described in detail using the drawings. Configurations, shapes, components, and the like described below are illustrative examples for explanation and can be appropriately changed in accordance with specifications of an underwater structure, a coating material, and an underwater fertilization material. Hereinafter, corresponding elements will be denoted by the same reference signs throughout the drawings, and repeated description will be omitted.

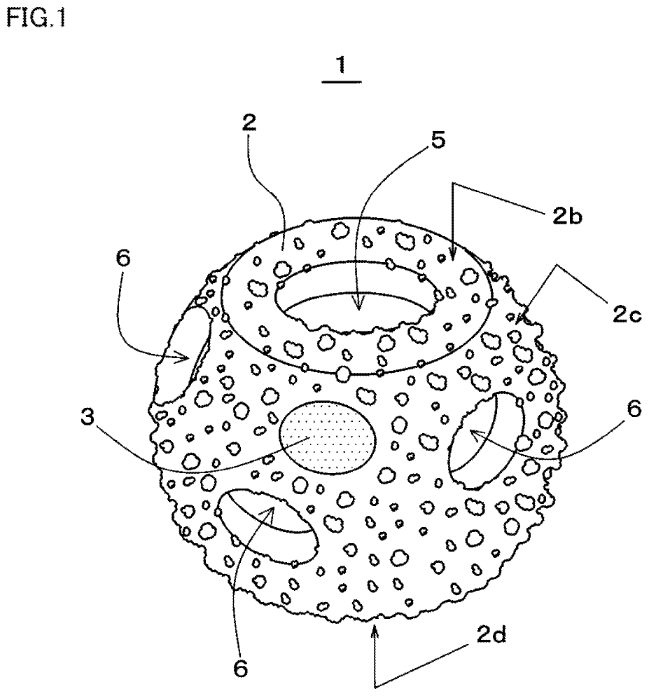

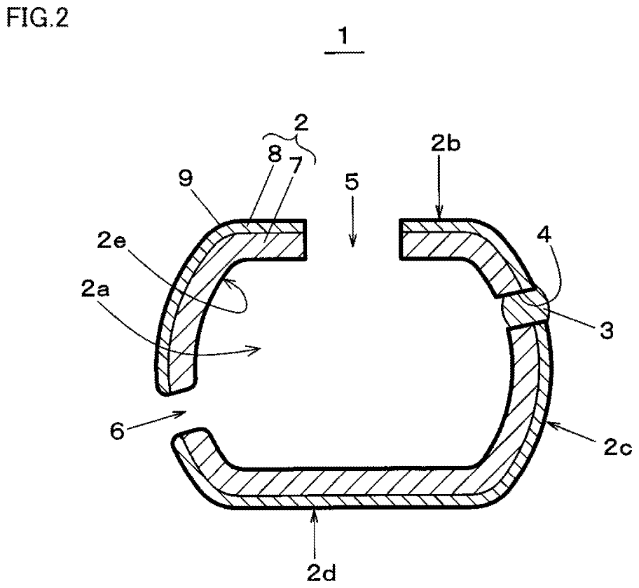

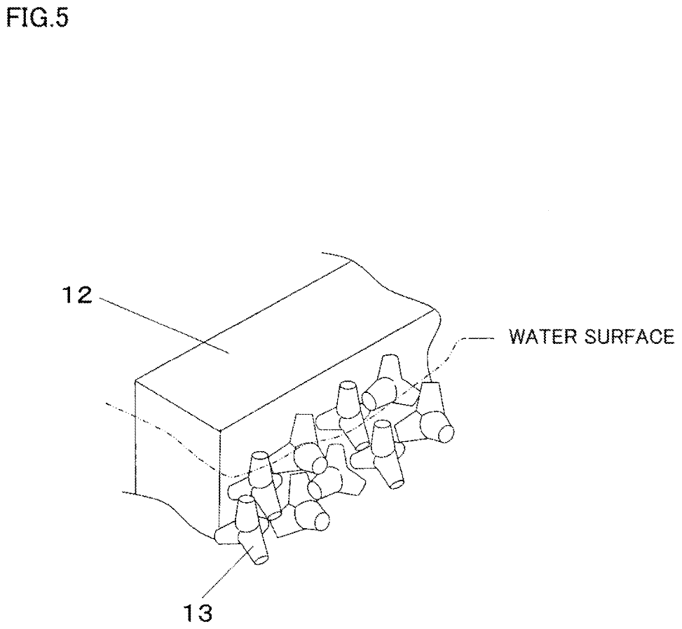

First, a configuration of an artificial reef 1 as an example of an underwater structure will be described with reference to FIGS. 1 and 2. Note that other underwater structures include caissons and the like, at least outer surfaces of which are partially disposed and installed in water, such as wave-dissipating blocks, a breakwater, and a quay as illustrated in FIGS. 5 to 10, and a part of a bridge, and the underwater structures are typically produced to include concrete, steel, and the like.

The artificial reef 1 is formed to include a main body 2 with a substantially spherical shape with an internal cavity 2a formed therein and a fertilization material (hereinafter, referred to as an “underwater fertilization material 3”) filling a holding portion 4 formed in the main body 2 and installed in water. At least one upper opening 5 penetrating up to the internal cavity 2a is formed at an upper portion 2b of the main body 2. Also, a plurality of side openings 6 penetrating up to the internal cavity 2a are formed at a side portion 2c of the main body 2. The artificial reef 1 is installed such that a bottom portion 2d of the main body 2 is grounded on a bottom of a sea. Note that the shape of the main body 2 may be any shape as long as the shape allows stable installation on the bottom of the sea and may be an irregular shape imitating a rock.

In FIG. 2, the main body 2 is formed to include a base portion 7 on the side of the internal cavity 2a and an outer shell portion 8 formed outside the base portion 7. The base portion 7 contains cement, pebbles, sand, diatomaceous earth, a water reducing agent, and the like and is formed of dense concrete. The base portion 7 can thus maintain strength for a long period of time even in sea water. The outer shell portion 8 contains cement, pebbles, sand, diatomaceous earth, a water reducing agent, and the like and includes many uneven shapes and minute pores formed therein. An outer surface of the main body 2 including the upper portion 2b, the side portion 2c, the bottom portion 2d, and an inner portion 2e (a surface of the base portion 7 forming the internal cavity 2a) of the main body 2 is coated with a coating material 9 containing iron fulvate (in a divalent iron state) through application or the like. The iron fulvate (in a divalent iron state) will be described later. In this manner, the main body 2 is formed to contain concrete, and at least the outer surface (the upper portion 2b and the side portion 2c) of the main body 2 includes many uneven shapes and minute pores. Seaweeds and the like can easily adhere to and grow on the outer surface of the artificial reef 1 by the outer surface of the main body 2 including many uneven shapes and minute pores. Note that the uneven shapes and the minute pores in the outer surface of the main body 2 are freely designed in accordance with types of adhering and cultivated seaweeds.

In FIG. 2, the holding portion 4 is formed to penetrate from the outer surface (side portion 2c) of the main body 2 through the outer shell portion 8 and the base portion 7 to the internal cavity 2a. The holding portion 4 is filled with the underwater fertilization material 3. The underwater fertilization material 3 is configured to contain iron fulvate (in a divalent iron state), and at least one of cement, sand, pebbles, silicon, diatomaceous earth, granular (with a diameter of 3 mm to 5 mm, for example) stone material, or the like. It is desirable that the stone material contained in the underwater fertilization material 3 contain an element such as magnesium, barium, strontium, or rubidium. A hydrogen-ion index (pH) of the underwater fertilization material 3 is less than 8 and is most desirably 7.7 to 7.9. The underwater fertilization material 3 can be caused to adhere to the inside of the holding portion 4 and the outer surface of the main body 2 in a solid state with cement. Also, the underwater fertilization material 3 can supply minerals and the like that are components necessary to raise seaweeds and the like little by little from the inside over a long period of time. Moreover, it is possible to moderately and stably supply minerals and the like by filling the holding portion 4 with the underwater fertilization material 3.

Note that it is only necessary for the underwater fertilization material 3 to be exposed to at least any of the internal cavity 2a and the outer surface of the main body 2. Also, the holding portion 4 is not necessarily completely filled with the underwater fertilization material 3, and the underwater fertilization material 3 may be in a state where a part of an inner wall of the holding portion 4 is stuffed therewith. Furthermore, a configuration in which a groove is formed in the outer surface (the upper portion 2b and the side portion 2c) of the main body 2 and the underwater fertilization material 3 is caused to adhere to the groove may also be employed. In this manner, it is only necessary for the artificial reef 1 to include the main body 2 and the underwater fertilization material 3 that is caused to adhere to at least a part of the main body 2 and contains cement, iron sulfide, and silicon.

As for the size of the artificial reef 1 in FIGS. 1 and 2, the height is about 20 cm to 2 m and is appropriately changed in accordance with a place of installation and types of seaweeds, fish and the like as targets of raising. For the artificial reef 1 with a height of 70 cm, for example, the thickness of the main body 2 including the base portion 7 and the outer shell portion 8 is 15 cm, and the weight is 170 kg. Also, the diameter of the upper opening 5 is 30 cm, the diameter of the side openings is 15 cm to 25 cm, and the diameter of the holding portion 4 is 10 cm to 15 cm. It is desirable that the upper opening 5 and the side openings 6 have sizes that allow fish inhabiting the location where the artificial reef 1 is installed to freely move between outside and the internal cavity 2a. Also, it is desirable that the weight (the thickness of the main body 2) be such a weight that prevents the artificial reef 1 from being moved by huge waves due to typhoons or the like.

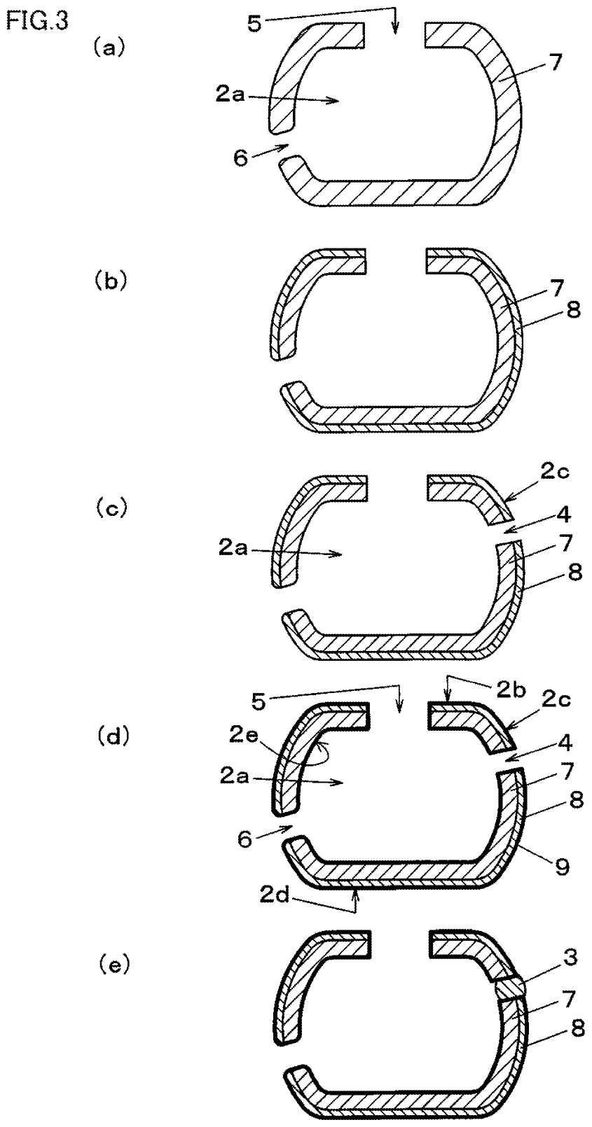

Next, a process of producing the artificial reef 1 will be described with reference to FIGS. 3A to 3E. First, fresh concrete (concrete that has not been hardened) containing predetermined materials that will serve as the base portion 7 is poured into a mold frame, and the base portion 7 is thereby created (FIG. 3A). Shapes that will serve as the internal cavity 2a, the upper opening 5, and the side openings 6 are formed in the mold frame in advance. Then, the outer surface part of the base portion 7 is worked, and the outer shell portion 8 including the many uneven shapes and minute pores is formed (FIG. 3B). Note that the outer shell portion 8 may be formed by working fresh concrete additionally applied to the outer surface of the base portion 7.

Next, the holding portion 4 penetrating up to the internal cavity 2a is formed in the side portion 2c of the main body 2 (FIG. 3C). The hole serving as the holding portion 4 is formed by a core drill or the like. Note that the holding portion 4 does not necessarily have a shape penetrating up to the internal cavity 2a and may be a recessed portion or may be a groove formed in the surface (the upper portion 2b, the side portion 2c, the bottom portion 2d, and the inner portion 2e) of the main body 2. Also, the position and the number of holding portions 4 can be appropriately designed. Additionally, the holding portion 4 may be formed in the upper portion 2b of the main body 2. Moreover, the holding portion 4 may be formed at the time of creation of the base portion 7 similarly to the upper opening 5 and the side openings 6.

Next, the coating material 9 is applied to the entire outer surface (the upper portion 2b, the side portion 2c, the bottom portion 2d, and the inner portion 2e) of the main body 2 including inner walls of the holding portion 4, the upper opening 5, and the side openings 6 formed in the main body 2 (FIG. 3D). The covering with the coating material 9 is not limited to the application, and it is only necessary for the main body 2 to be covered therewith. Although description will be given later, the coating material 9 contains iron sulfide and may be applied to the main body 2 with an air gun and the like or may be applied by immersing the main body 2 in a liquid agent stored in a container (tank) and containing iron sulfide. The iron sulfide applied to the outer surface of the main body 2 (outer shell portion 8) invades concrete, forms an iron sulfide-containing layer, and can thus prevent calcium hydroxide from flowing out to water.

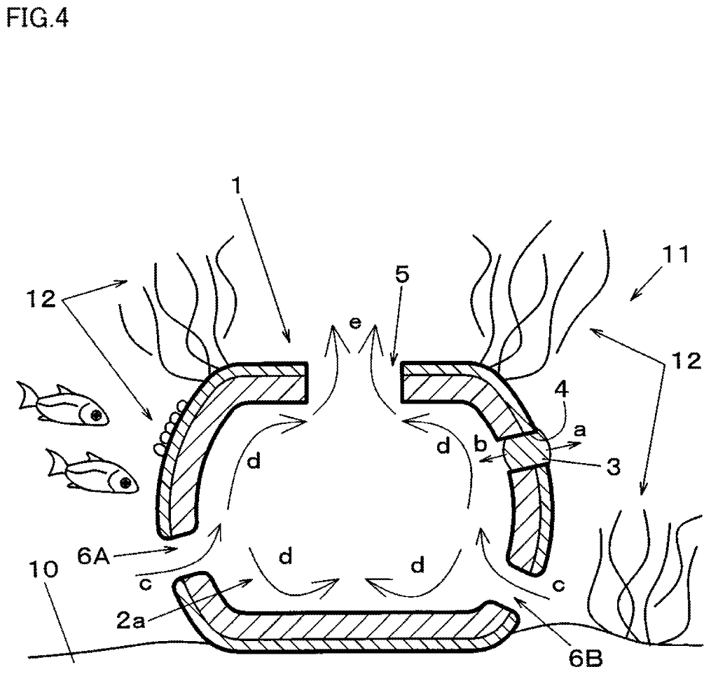

Next, water is added to predetermined materials which will serve as the underwater fertilization material 3 to obtain a paste-form substance. Next, the paste-form substance is formed into a predetermined shape through filling of and adhering to the holding portion 4 and the like (FIG. 4E). Thereafter, the substance is dried to thereby obtain the underwater fertilization material 3 as a solid. In this manner, it is possible to easily create the underwater fertilization material 3 in the present embodiment in various shapes by adding water to obtain the paste-form substance and filling predetermined locations therewith and causing the substance to adhere to the locations. Also, the substance becomes a solid after the drying and can supply contained minerals and the like into water little by little over a long period of time.

Next, functions of the artificial reef 1 will be described with reference to FIG. 4. FIG. 4 illustrates the artificial reef 1 installed on a bottom of a sea 10. The underwater fertilization material 3 filling the holding portion 4 of the artificial reef 1 supplies minerals to sea water 11 outside (arrow a) of the artificial reef 1 and in the internal cavity 2a (arrow b). A water flow (arrows c) flowing from a side opening 6A and a side opening 6B of the artificial reef 1 into the internal cavity 2a flows inside the internal cavity 2a (arrows d) and flows out from the upper opening 5 to the outside of the artificial reef 1 (arrows e). In this manner, the minerals supplied from the underwater fertilization material 3 to the internal cavity 2a are supplied far away from the artificial reef 1.

In this manner, the internal cavity 2a is formed inside the main body 2 and communicates with the outside of the main body 2 through the upper opening 5 and the side openings 6A and 6B. Also, it is desirable that the holding portion 4 be disposed at a location above any of the plurality of side openings 6A and 6B. In this manner, it is possible to efficiently supply, from the upper opening 5 to the outside, the minerals leaching from the underwater fertilization material 3 filling the holding portion 4 into the internal cavity 2a.

Also, the side openings 6A and 6B and the upper opening 5 cause huge waves generated by typhoons or the like and rushing in the side portion 2c of the artificial reef 1 to flow out from the side openings 6A and 6B to the upper opening 5 and can thus disperse a force that causes the artificial reef 1 to move in a lateral direction. It is thus possible to prevent the artificial reef 1 installed at a sandy place or a gravel place from moving from the place of installation, falling down, or being buried in sand and to thereby maintain a stable state. Furthermore, it is also possible to prevent the underwater fertilization material 3 from being scattered and lost due to huge waves by causing the underwater fertilization material 3 to adhere to the holding portion 4.

Seaweeds and the like are cultivated on the outer surface (the upper portion 2b and the side portion 2c) of the artificial reef 1 and the bottom of the sea 10 around the artificial reef 1 with components such as minerals supplied from the underwater fertilization material 3 in this manner. In other words, the artificial reef 1 with the underwater fertilization material 3 adhering thereto is an underwater fertilization structure that supplies minerals and the like necessary to raise seaweeds and coral reefs to water. Note that the underwater structure may be a wave-dissipating block or the like installed in water, on the seashore, or on a riverbank, as well as the artificial reef 1.

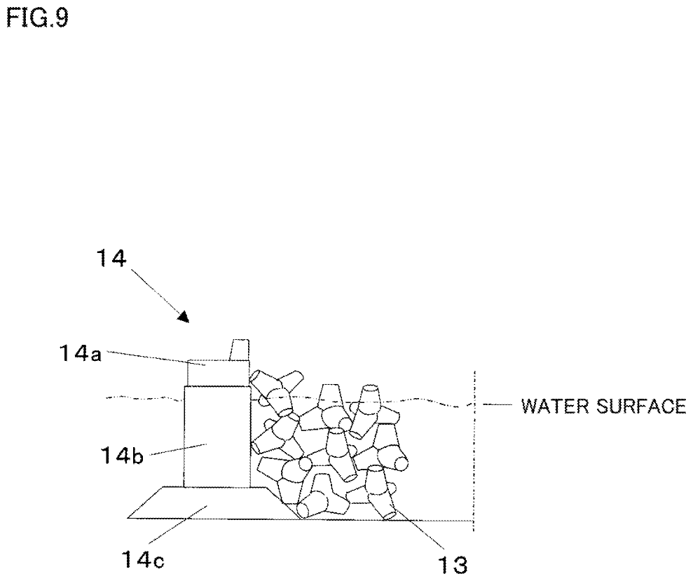

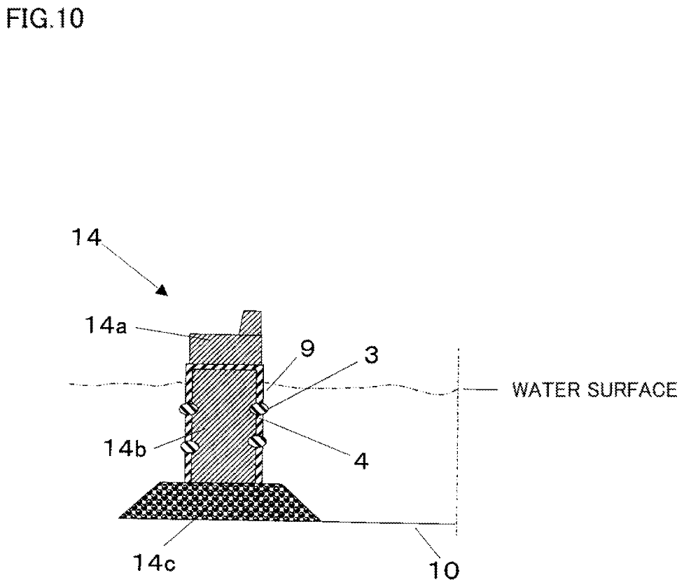

Here, an example in which the underwater structure is not the artificial reef 1 will be described. Cases where the underwater structure is a quay 12 and (or) wave-dissipating blocks 13 will be described with reference to FIGS. 5 to 8A and 8B, and cases where the underwater structure is a breakwater 14 and (or) the wave-dissipating blocks 13 will be described with reference to FIGS. 9 and 10.

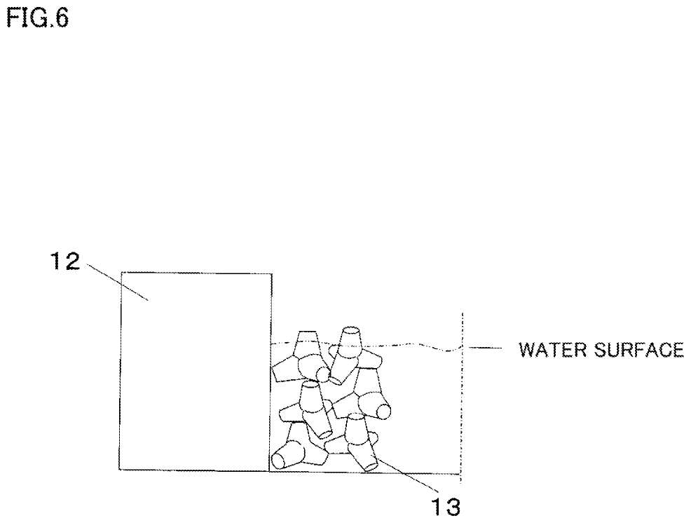

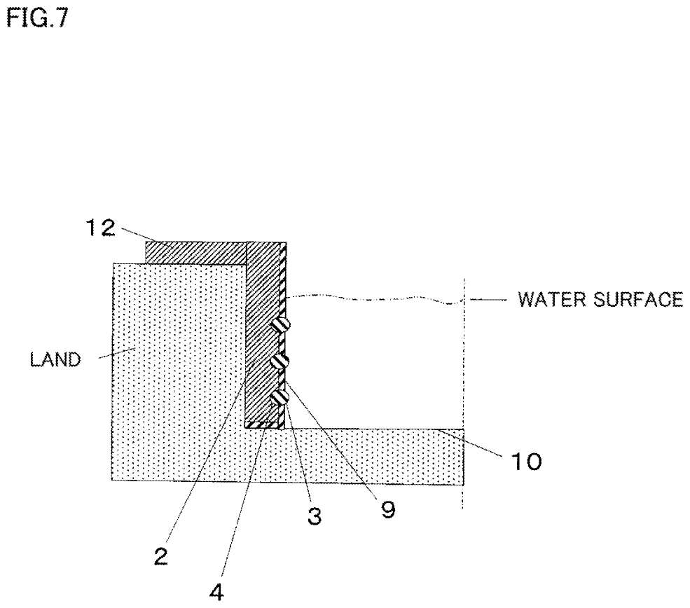

As illustrated in FIGS. 5 and 6, the quay 12 and the wave-dissipating blocks 13 that are underwater structures are at least partially installed in water. As in FIG. 7, the quay 12 is configured to overlap the seashore, and the main body 2 is thus installed at a part of a boundary between the land and the seashore. Therefore, the outer surface of the quay 12 at least at a part where the main body 2 comes into contact with sea water is covered with the coating material 9. It is a matter of course that the entire outer surface of the quay 12 may be covered with the coating material 9. Also, it is possible to dispose one or a plurality of underwater fertilization materials 3 by, for example, providing the holding portion 4 at a part of the outer surface where the quay 12 comes into contact with sea water. Moreover, the quay 12 between the main body 2 and the bottom of the sea 10 may also be covered with the coating material 9.

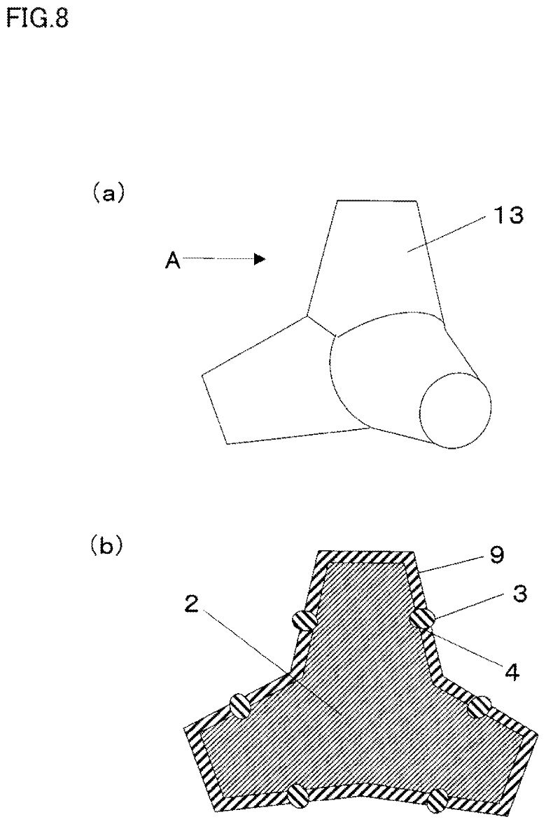

Also, FIG. 8A is the wave-dissipating block 13, and FIG. 8B is a substantial sectional view of the wave-dissipating block 13 seen from the direction A in FIG. 8A. As in FIG. 8B, at least a part of the outer surface of the main body 2 of the wave-dissipating block 13 that comes into contact with sea water is covered with the coating material 9, and the entire outer surface may be covered therewith. It is possible to dispose one or a plurality of underwater fertilization materials 3 by, for example, providing the holding portion 4 at a part of the outer surface where the wave-dissipating block 13 comes into contact with sea water.

Also, in a case where the underwater structure is the breakwater 14, the breakwater 14 and the wave-dissipating blocks 13 that are underwater structures are at least partially installed underwater as illustrated in FIG. 9. Since the breakwater 14 is installed away from a seashore, a base stone material 14c is provided at the lowermost portion on the bottom of the sea 10, a caisson 14b is installed on the base stone material 14c, and concrete 14a is installed at an upper portion. Although at least parts of outer surfaces of the caisson 14b and the base stone material 14c that come into contact with sea water are covered with the coating material 9, the entire outer surfaces may be covered therewith. It is a matter of course that at least a part of an outer surface of the concrete 14a may be covered with the coating material 9. One or a plurality of underwater fertilization materials 3 can be disposed by, for example, providing the holding portion 4 at a part of the outer surface of the caisson 14b, for example, where the breakwater 14 comes into contact with the sea water.

Next, iron fulvate (in a divalent iron state) contained in the coating material 9 and the underwater fertilization material 3 will be described. As described above, seaweeds have decreased and sea desertification has advanced in coastal areas and the like. Although iron fulvate generated in forest humic planting soil used to flow from rivers, the amount thereof has decreased in recent years. Thus, although it is desired to supply a fulvic acid to sea water, ordinary divalent iron fulvate (divalent iron ion) is likely to be oxidized by oxygen in water, is changed into trivalent iron fulvate (trivalent iron ion), immediately settles out as granular iron, and cannot be taken by living organisms.

Furthermore, divalent iron fulvate (divalent iron ion) also reacts with calcium hydroxide contained in concrete and is turned into trivalent iron fulvate (trivalent iron ion). In this case, calcium hydroxide in concrete that is often used for underwater structures is also dissolved, which also leads to degradation of durability of the concrete. In this manner, installation of concrete in water in an exposed manner is not preferable for marine environments in the first place since divalent iron fulvate (divalent iron ion) in water is changed to trivalent iron fulvate (trivalent iron ion), sea desertification is promoted, and degradation of concrete is prompted.

Therefore, the present disclosure provides the coating material 9 and the underwater fertilization material 3 containing fulvic acid that can maintain the divalent state for a longer period of time even in water and a structure that prevents concrete degradation.

First, a fulvic acid that can maintain the divalent state even in water will be described here. Iron fulvate (in a divalent iron state) is produced by dissolving each of iron (II) sulfate preferably with pH of equal to or less than 4 and a fulvic acid in fresh water and mixing them, for example. In other words, it is only necessary to constantly cause the change to iron fulvate in an acidic condition. Iron fulvate becomes unlikely to be changed to trivalent iron for a long period of time even if the iron fulvate comes into contact with water/sea water by using iron (II) sulfate with pH of equal to or less than 4. In terms of the weight, at least 0.001 to 0.1% of fulvic acid is preferably blended with respect to iron (II) sulfate.

Coating (which may be application) of the coating material 9 is achieved by, for example, spraying iron fulvate (in a divalent iron state) produced by dissolving iron (II) sulfate and a fulvic acid in fresh water by the above method to the entire main body 2. Even in a case of an underwater structure (for example, a wave-dissipating block, a breakwater, or a quay) other than the artificial reef 1, at least an outer surface part of the underwater structure that comes into contact with water is covered. It is a matter of course that the entire outer surface may be covered.

Since the iron sulfide-containing layer is formed by covering the entire outer surface with the coating material 9 as an outer surface treatment for the outer surface of the underwater structure in this manner, dissolution of calcium hydroxide in concrete contained in the underwater structure into water is curbed, and it is possible to curb degradation of the strength of the underwater structure. It is also possible to prevent iron fulvate from being oxidized with calcium hydroxide in concrete and to thereby supply iron fulvate in a divalent iron state to water for a long period of time.

Note that as a role of the coating material 9, cultivation of seaweeds is promoted by supplying iron fulvate, which is one of components, to water. At the same time, calcium hydroxide of concrete contained in the underwater structure is prevented from flowing out to water by continuously covering the outer surface of the underwater structure therewith for a long period of time. Therefore, the coating material 9 has a role achieved by being dissolved in water and a role achieved by remaining on the outer surface of the underwater structure. Therefore, a thickness of 3 mm is needed at a minimum, and a preferable thickness is about 5 mm to 10 mm, in order to continuously play the two roles for a long period of time. However, in a case where the outer surface of the main body 2 is uneven, the thickness of the coating material 9 varies depending on the uneven shape.

Also, the underwater fertilization material 3 can be produced by mixing appropriate amounts of cement, sand, small pebbles, micro silica, natural ores, rock salts, and the like with sea water and mixing, into the mixture, iron fulvate (in a divalent iron state) generated by dissolving each of iron (II) sulfate preferably with pH of equal to or less than 4 and a fulvic acid in fresh water, putting them together, and causing a reaction therebetween. Natural ores, rock salts, and the like may be added not only when the underwater fertilization material 3 is produced but also when the coating material 9 is produced. In this manner, nutrient salts including natural ores, rock salts, and the like are dissolved from the coating material 9 into water even in a case where the underwater fertilization material 3 is not used, and cultivation of seaweeds is prompted.

Note that it is possible to adjust the hydrogen-ion index (pH) around the outer surface where the artificial reef 1 comes into contact with sea water to achieve an environment suitable for growth of seaweeds by forming the coating material 9 containing iron sulfide and the like on the outer surface (the upper portion 2b, the side portion 2c, the bottom portion 2d, and the inner portion 2e) of the main body 2. For example, the hydrogen-ion index (pH) near the outer surface where the artificial reef 1 comes into contact with sea water is desirably 7.8 to 8.4 which is similar to that of the sea water.

Note that although the underwater structures installed mainly in sea water have been described in the above description, the underwater structures have been increasingly used, for example, when bottoms of rivers and riverbanks are hardened flow with concrete in riverbank protection works and the like due to river overflows resulting from heavy rainfall disasters. Since such underwater structures installed in water in rivers and the like other than seas may also affect seas due to overflows and the like, the present disclosure is preferably applied.

A coating material for underwater structures for stably supplying components necessary to raise seaweeds and the like and an underwater structure covered with the coating material are provided.
1 Artificial reef (underwater fertilization structure)
2 Main body
2a Internal cavity
2b Upper portion (outer surface)
2c Side portion (outer surface)
3 Underwater fertilization material
4 Holding portion
5 Upper opening
6, 6A, 6B Side opening

1. A coating material for underwater structures comprising:
iron (II) fulvate generated by causing at least iron (II) sulfate and a fulvic acid to react, wherein an outer surface of an underwater structure that is at least partially installed in water is coated with the coating material.

2. The coating material for underwater structures according to claim 1, wherein the coating material for underwater structures is sprayed and applied to the outer surface of the underwater structure.

3. An underwater structure comprising:
a main body; and
a coating material provided on an outer surface of the main body and containing iron (II) fulvate generated by causing iron (II) sulfate and a fulvic acid to react.

4. The underwater structure according to claim 3, wherein a thickness of the coating material is 3 to 10 mm.

5. A method for producing an underwater structure with a coating material comprising:
forming an underwater structure that is for being at least partially installed in water; and
coating an outer surface of the underwater structure with a coating material containing iron (II) fulvate generated by causing at least iron (II) sulfate and a fulvic acid to react.
